(19) United States
(12) Patent Application Publication
(10) Pub. No.: US 2005/0232100 A1
(43) Pub. Date: Oct. 20, 2005

(54) Optical disk apparatus

(75) Inventor: Hiroyuki Kogure, Gunma-ken (JP)

Correspondence Address: SoCAL IP LAW GROUP LLP, 310 N. WESTLAKE BLVD. STE 120, WESTLAKE VILLAGE, CA, 91362, US

(73) Assignee: Sanyo Electric Co., Ltd., Osaka (JP)

(21) Appl. No.: 11/107,229

(22) Filed: Apr. 14, 2005

(30) Foreign Application Priority Data
Apr. 16, 2004 (JP) 2004-121547

(51) Int. Cl. G11B 7/00

(52) U.S. Cl. 369/44.35; 369/44.11

(57) ABSTRACT

An optical disk apparatus comprises a speed detector that detects the speed of an optical pickup when the optical pickup moves from a first track to a second track of an optical disk medium, a level variable unit that makes variable the level of an objective lens-use pulse in accordance with the detection result of the speed detector, a drive unit that changes the opposing position of the objective lens with respect to the radial direction of the optical disk medium in accordance with the level of the objective lens-use pulse.

### CROSS-REFERENCE TO RELATED APPLICATIONS

The present application claims priority upon Japanese Patent Applications No. 2004-121547 filed on Apr. 16, 2004, which is herein incorporated by reference.

### BACKGROUND OF THE INVENTION

1. Field of the Invention

The present invention relates to an optical disk apparatus.

2. Description of the Related Art

In recent years, optical disk media (e.g., compact disks (CDs) and digital versatile disks (DVDs)) have been used as storage media for recording or playing back data (e.g., music and video). Optical disk apparatuses for playing the optical disk media have also spread in accompaniment with the spread of optical disk media.

Rows of pits (hereinafter referred to as “tracks”) are formed in a spiral manner from the inner periphery to the outer periphery of optical disk media in which such data are recorded. When reading the data recorded in an optical disk medium, the optical disk apparatus irradiates the optical disk medium with laser light from an objective lens disposed in an optical pickup. At this time, the tracks must be precisely irradiated with the laser light emitted from the objective lens. For this reason, the optical disk apparatus conducts control such as tracking and focusing with respect to the objective lens. Here, tracking refers to controlling the objective lens by moving the objective lens in the radial direction so that the tracks are precisely irradiated with the laser light when vibration occurs in the radial direction due to eccentricity or the like of the optical disk medium. In other words, the irradiation position of the objective lens in the radial direction with respect to the optical disk apparatus is controlled by an actuator that supports the objective lens.

When reading the necessary data from the data recorded in the optical disk medium, the optical disk apparatus moves the optical pickup (hereinafter referred to as “track jumping”) to the track (hereinafter referred to as “the target track”) in which the necessary data are recorded. Then, the optical disk apparatus carries out tracking control with respect to the objective lens and irradiates the target track with the laser light. Specifically, at the time of track jumping, the optical pickup moves in the radial direction of the optical disk medium. Then, when the optical pickup arrives at the target track, a pulse for controlling the actuator is supplied to the actuator in order for the objective lens to irradiate the target track with the laser light. This pulse is for changing the irradiation position of the objective lens with respect to the optical disk medium using the level of the pulse, and is a constant pulse. See for example Japanese Patent Application Laid-open Publication No. 2002-245642.

However, there have been instances where the moving speed of the optical pickup changes due to eccentricity or the like of the optical disk medium. In this instance, sometimes the objective lens receives more than the usual inertial force of the optical pickup because the pulse is at a constant level, whereby the actuator becomes unable to be normally controlled by the pulse and the objective lens becomes shifted from the target track in the radial direction. For this reason, there has been the problem that the time necessary for the tracking to the target track after track jumping becomes long. Alternatively, there have been instances where the shifting from the target track is not in a range that can be controlled with tracking by the objective lens, and the irradiation of the laser light to the target track fails. In this instance, the problem has arisen that track jumping must be repeated once again.

### SUMMARY OF THE INVENTION

It is an object of the present invention to provide an optical disk apparatus that can precisely irradiate an optical disk medium with laser light regardless of the moving speed of the optical pickup.

In order to cope with this problem, one aspect of the present invention provides an optical disk apparatus comprising a pulse generator which, when an optical pickup including an objective lens for emitting laser light for recording or playing back information with respect to an optical disk medium has moved in a radial direction of the optical disk medium from a first track formed to a second track in the optical disk medium, generates an objective lens-use pulse for determining an opposing position of the objective lens with respect to the radial direction of the optical disk medium, a drive unit that determines the opposing position of the objective lens on the basis of the objective lens-use pulse, a speed detector that detects the speed of the optical pickup when the optical pickup moves from the first track to the second track, and a level variable unit that makes variable the level of the objective lens-use pulse in accordance with the detection result of the speed detector, wherein the drive unit changes the opposing position of the objective lens with respect to the radial direction of the optical disk medium in accordance with the level of the objective lens-use pulse.

According to the present invention, an optical disk apparatus can be provided which can precisely irradiate an optical disk medium with laser light regardless of the moving speed of the optical pickup.

### BRIEF DESCRIPTION OF THE DRAWINGS

For a more complete understanding of the present invention and the advantages thereof, reference is now made to the following description taken in conjunction with the accompanying drawings wherein:

FIG. 1 is a functional block diagram showing an example of the configuration of a track jump processing unit and a tracking servo processing unit of an optical disk apparatus pertaining to the invention;

FIG. 2 is a waveform diagram showing the relationship between a tracking error signal and a TES signal with respect to tracks of an optical disk medium, and is a cross-sectional view of the optical disk;

FIG. 3 shows a waveform diagram showing the relationship between the tracking error signal, the TES signal and a clock signal in track jumping of the objective lens, and a timing chart of a track jump control pulse and an objective lens-use pulse C;

FIG. 4 is a flow chart showing the operation of the optical disk apparatus pertaining to the invention; and

FIG. 5 is a functional block diagram showing the overall configuration of an optical disk playback apparatus applying the optical disk apparatus of the invention.

### DETAILED DESCRIPTION OF THE INVENTION

At least the following will become apparent from the description of the specification and the attached drawings.

<<Overall Configuration of Optical Disk Playback Apparatus>>

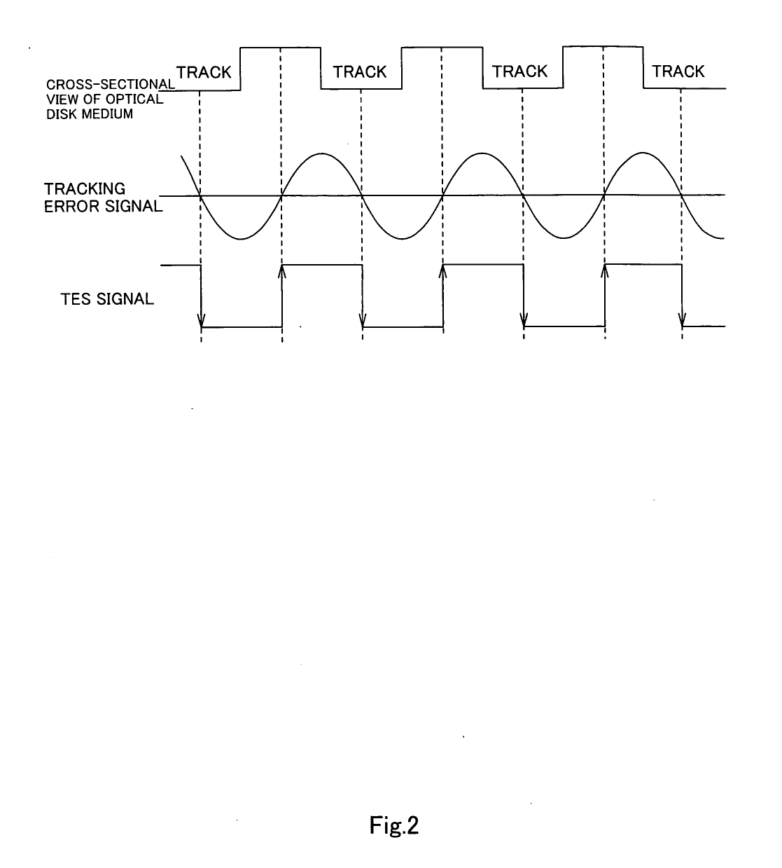

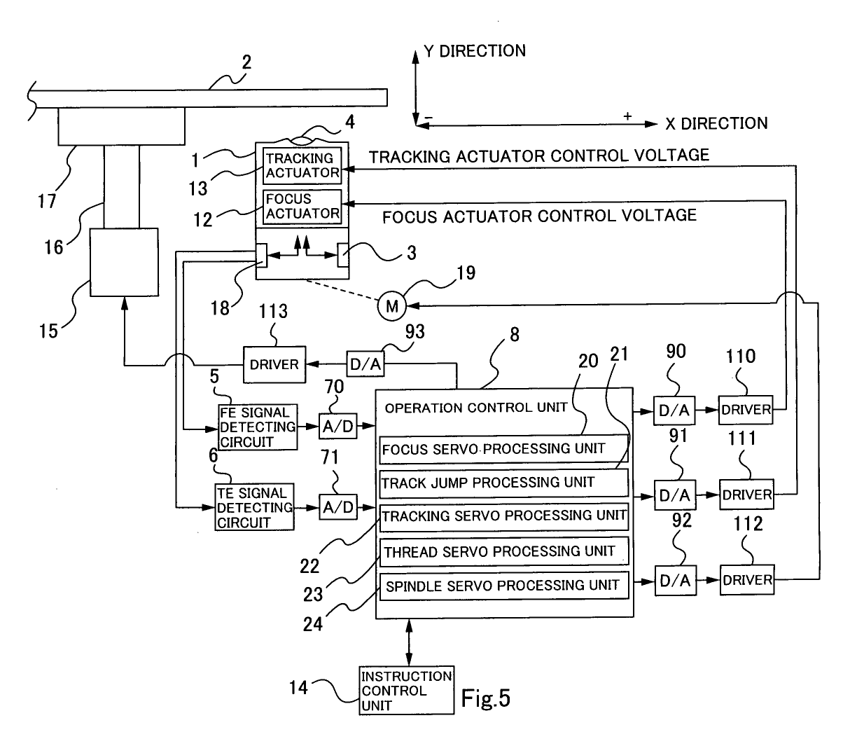

The overall configuration of an optical disk playback apparatus or the like applying the optical disk apparatus of the invention will be described with reference to FIGS. 2 and 5. FIG. 2 is a waveform diagram showing the relationship between a tracking error signal and a TES signal with respect to the tracks of an optical disk medium. In FIG. 2, a cross-sectional view of the optical disk medium shows the location of the tracks. FIG. 5 is a functional block diagram showing the overall configuration of the optical disk playback apparatus applying the optical disk apparatus of the invention. In the present embodiment, an optical disk medium 2 will be described as a compact disk (CD) in which music data are recorded, but the optical disk medium 2 is not limited to this. For example, the optical disk medium 2 may also be a digital versatile disk (DVD) or a mini disc (MD) in which data (music, video, etc.) are recorded.

As shown in FIG. 5, the optical disk playback apparatus is disposed with an optical pickup 1 that includes a laser diode 3, an objective lens 4, a light detector 18, a focus actuator 12 and a tracking actuator 13. The optical pickup 1 emits laser light for reading the music data from the optical disk medium 2. The optical pickup 1 is disposed with the laser diode 3 as a light source and irradiates, via the objective lens 4, the tracks formed in the optical disk medium 2 with the laser light received from the laser diode 3. The light detector 18 receives the laser light reflected from the optical disk medium 2. The objective lens 4 is a dual focal point lens, for example, and is supported by the focus actuator 12 and the tracking actuator 13.

An FE (focus error) signal detecting circuit 5 generates a focus error signal from the laser light that the light detector 18 has received. The focus error signal represents vibration in the surface-perpendicular direction (the Y direction shown in FIG. 5) resulting from surface vibration of the optical disk medium 2, for example.

A TE (tracking error) signal detecting circuit 6 generates a tracking error signal from the laser light that the light detector 18 has received. The tracking error signal represents vibration in the radial direction (the X direction shown in FIG. 5) resulting from eccentricity of the optical disk medium 2, for example.

An A/D converter 70 converts the focus error signal generated by the FE signal detecting circuit 5 from an analog value to a digital value. An A/D converter 71 converts the tracking error signal generated by the TE signal detecting circuit 6 from an analog value to a digital value (the tracking error signal converted to the digital value will be hereinafter referred to as a “TES signal” below).

As shown in FIG. 2, the TE signal detector 6 generates a sinusoidal tracking error signal corresponding to the location of the tracks when the optical pickup 1 moves in the radial direction of the optical disk medium 2. The sinusoidal tracking error signal has one period in between the tracks formed in the optical disk medium 2. The A/D converter 71 outputs the TES signal in which the tracking error signal has been converted from the analog value to the digital value. The A/D converter 71 may be realized by a comparator that compares the tracking error signal with a predetermined reference voltage. For example, the TES signal becomes a high level when the tracking error signal is greater than the reference voltage and becomes a low level when the tracking error signal is less than the reference voltage.

An operation control unit 8 includes a focus servo processing unit 20, a track jump processing unit 21, a tracking servo processing unit 22, a thread servo processing unit 23 and a spindle servo processing unit 24. The operation control unit 8 is configured by a digital signal processor (DSP), for example.

The focus servo processing unit 20 outputs, to a D/A converter 90, a focus control pulse for correcting the irradiation position of the laser light resulting from vibration of the optical disk medium 2 in the Y direction on the basis of the focus error signal from the A/D converter 70. The D/A converter 90 converts the focus control pulse to an analog value. A driver 110 outputs the analog value from the D/A converter 90 as a focus actuator control voltage. The focus actuator 12 includes a focus control coil (not shown). The focus actuator 12 moves the objective lens 4 in the Y direction as a result of the focus actuator control voltage being applied to the focus control coil. In other words, the focus actuator 12 conducts drive control of the objective lens 4 in the Y direction in accordance with the focus actuator control voltage.

An instruction control unit 14 controls the entire optical disk apparatus pertaining to the reading or writing of the music data recorded in the optical disk medium 2. When the instruction control unit 14 receives an instruction signal from a remote controller or the like (not shown) to select a song selection or fast-forward through the music data recorded in the optical disk medium 2, the instruction control unit 14 transmits a track jump signal to the track jump processing unit 21, the tracking servo processing unit 22 and the thread servo processing unit 23. When the instruction control unit 14 receives the instruction control signal, the instruction control unit 14 calculates the number of tracks from the track being irradiated with the laser light by the objective lens 4 to the target track, and sets the number of tracks in the track jump processing unit 21 as a target track value.

When the track jump processing unit 21 receives the track jump signal from the instruction control unit 14, the track jump processing unit 21 conducts control for moving the objective lens 4 from the track being irradiated with the laser light by the objective lens 4 (first track) to the track in which the selected music data are recorded (second track; hereinafter referred to as “the target track”). In the present embodiment, the movement of the objective lens 4 to the target track will be described as moving from the inner peripheral side to the outer peripheral side of the optical disk medium 2 (i.e., in the +X direction).

The tracking servo processing unit 22 outputs, to a D/A converter 91, a tracking control pulse for correcting the irradiation position of the laser light resulting from vibration of the optical disk medium 2 in the Y direction on the basis of the TES signal from the A/D converter 71. The D/A converter 91 converts the tracking control pulse to an analog value. A driver 111 outputs the analog value from the D/A converter 91 as a tracking actuator control voltage. The tracking actuator 13 includes a tracking control coil (not shown). The tracking actuator 13 moves the objective lens 4 in the X direction as a result of the tracking actuator control voltage being applied to the tracking control coil. In other words, the tracking actuator 13 conducts drive control of the objective lens 4 in the X direction in accordance with the focus actuator control voltage.

The thread servo processing unit 23 outputs a thread control pulse to a D/A converter 92 on the basis of the track jump signal from the instruction control unit 14. The D/A converter 92 converts the thread control pulse to an analog value. A driver 112 outputs the analog value from the D/A converter 92 as a thread control voltage and applies this to a thread motor 19. In other words, the rotational speed and rotational direction of the thread motor 19 are controlled by the thread control voltage. As a result, the movement, in the X direction, of the optical pickup 1 coupled to a rotating shaft (not shown) of the thread motor 19 is controlled.

A turntable 17 is fixed to a rotating shaft 16 of a spindle motor 15. The spindle servo processing unit 24 controls the rotational speed of the optical disk medium 2 disposed on the turntable 17. Specifically, the spindle servo processing unit 24 uses a synchronizing signal and a bit clock extracted from the data signal of the optical disk medium 2 to generate a spindle control pulse for controlling the rotation of the optical disk medium 2 at a constant linear velocity, and outputs the spindle control pulse to a D/A converter 93. Alternatively, the spindle servo processing unit 24 generates the spindle control pulse in synchronization with an ATIP signal demodulated by an ATIP (Absolute Time In Pre-groove) decoder and outputs the spindle control pulse to the D/A converter 93. The D/A converter 93 converts the spindle control pulse from the spindle servo processing unit 24 to an analog value. A driver 113 outputs the analog value from the D/A converter 93 as a spindle control voltage and applies this to the spindle motor 15. In other words, the rotational speed of the spindle motor 15 is controlled by the spindle control voltage.

<<Configural Examples of the Track Jump Processing Unit and the Tracking Servo Processing Unit >>

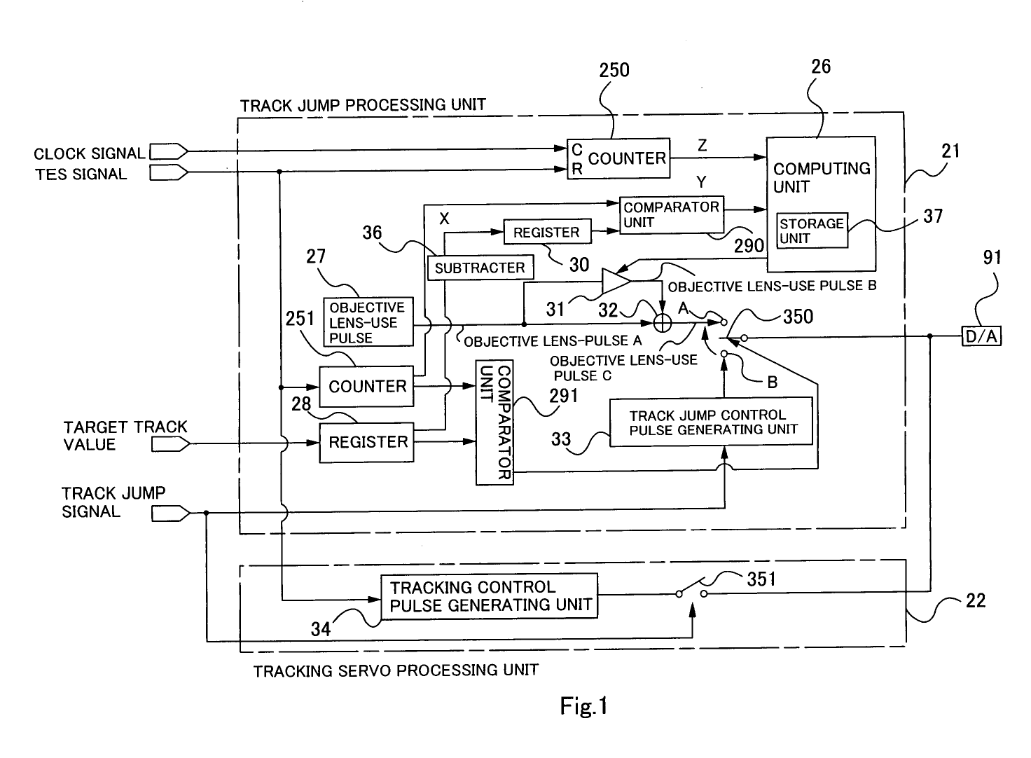

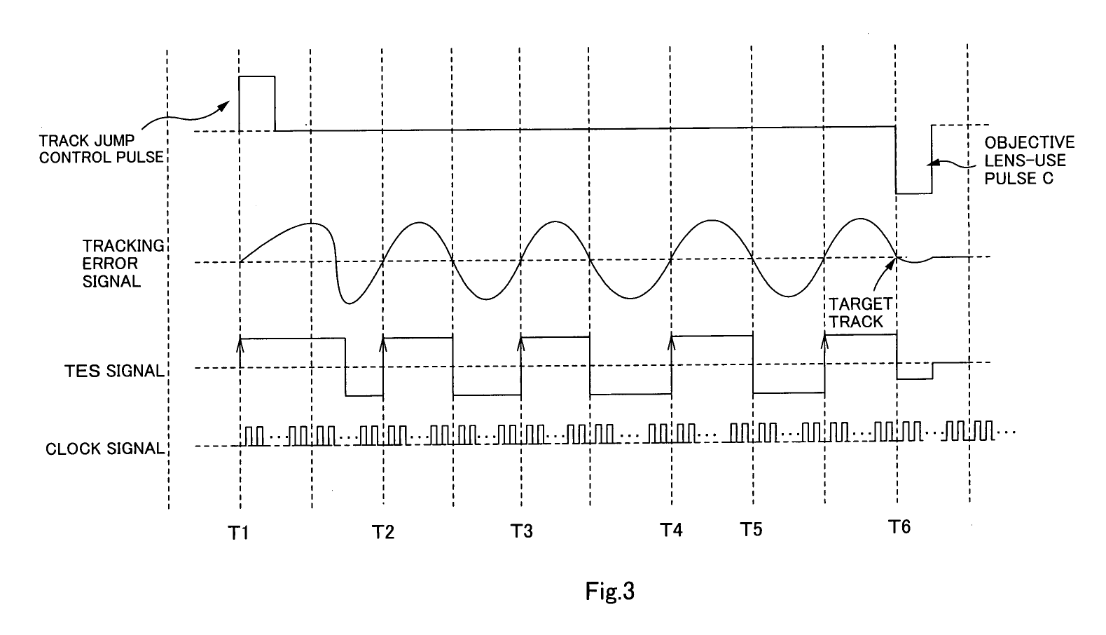

The track jump processing unit and the tracking servo processing unit of the optical disk apparatus pertaining to the invention will be described with reference to FIGS. 1, 3 and 5. FIG. 1 is a functional block diagram showing an example of the configuration of the track jump processing unit and the tracking servo processing unit of FIG. 5. FIG. 3 is a waveform diagram showing the relationship between the tracking error signal, the TES signal and the clock signal in the track jumping of the objective lens. FIG. 3 also shows the presence of a track jump control pulse and an objective lens-use pulse C.

As shown in FIG. 1, the tracking servo processing unit 22 includes a tracking control pulse generating unit 34 and a switch 351.

The tracking control pulse generating unit 34 generates, on the basis of the TES signal, the tracking control pulse for correcting the irradiation position of the laser light resulting from vibration of the optical disk medium 2 in the X direction, and outputs the tracking control pulse to the D/A converter 91.

The switch 351 is closed when the objective lens 4 is not track jumping (hereinafter referred to as “normally”). The switch 351 is opened by a track jump instruction signal from the instruction control unit 14. In other words, when the switch 351 opens, the tracking control pulse generated by the tracking control pulse generating unit 351 is no longer outputted to the D/A converter 91. Thus, at the time of the track jumping of the objective lens 4, the control of the objective lens 4 in the X direction by the tracking servo processing unit 22 is no longer conducted.

The track jump processing unit 21 includes counters (speed detectors) 250 and 251, a computing unit 26 (storage unit and level variable unit), an objective lens-use pulse generating unit 27 (pulse generator), registers 28 and 30, comparator units 290 and 291, a multiplier 31 (level variable unit), an adder 32 (level variable unit), a track jump control pulse generating unit 33, and a switch 350.

One end of the switch 350 is normally connected to a contact point B, and the other end of the switch 350 is connected to the D/A converter 91. The switch 350 is connected to a contact point A on the basis of a switching signal from the comparator unit 291. Also, when the switching signal from the comparator unit 291 is no longer outputted, the switch 350 is connected to the contact point B.

When the track jump control pulse generating unit 33 receives the track jump signal from the instruction control unit 14, the track jump control pulse generating unit 33 generates a track jump control pulse in order to move the objective lens 4 in the +X direction and outputs the track jump control pulse to the D/A converter 91 via the switch 350. In the present embodiment, the track jump control pulse generating unit 33 will be described as generating a track jump control pulse that projects to the upper side of the page of FIG. 3 when the objective lens 4 is moved in the +X direction. For this reason, when the objective lens 4 is moved in the −X direction (from the outer peripheral side to the inner peripheral side), the track jump control pulse generating unit 33 generates a track jump control pulse that projects to the lower side of the page of FIG. 3 (not shown).

The counter 251 counts the launches of the TES signal.

The register 28 stores the target track value transmitted from the instruction control unit 14.

The comparator unit 291 compares the counted value of the counter 251 with the target track value stored in the register 28. When these values match, the comparator unit 291 outputs the switching signal to switch the end of the switch 350 from the contact point B to the contact point A.

The counter 250 includes a C terminal, to which a clock signal with a predetermined frequency (e.g., 2 MHz) is inputted, and an R terminal (reset), to which the TES signal is inputted. The counter 250 counts the number of periods of the clock signal per one period of the TES signal. Specifically, the counter 250 counts the changes in the clock signal (e.g., launches of the clock signal) in one period of the TES signal (e.g., one period from the launch of the TES signal to the next launch). The counter 250 is reset by a change in the launch of the TES signal. Thus, the counter 250 can count the number of periods of the clock signal in each period of the TES signal. The counter 250 also outputs, to the computing unit 26, a counted value Z, which is the number of periods of the clock signal per period of the TES signal.

A subtracter 36 subtracts a predetermined value n (e.g., 1) from the target track value stored in the register 28. The subtracter 36 also stores the subtracted value X (target track value−n) in the register 30. Here, n is for setting the timing for transmitting a signal Y to the computing unit 26. For example, when n=1 is set in the subtracter 36, the comparator unit 290 transmits the signal Y to the computing unit 26 when the objective lens 4 has reached the track that is one track before the target track.

The comparator unit 290 compares the counted value of the counter 251 with the value X stored in the register 30. When the values match, the comparator unit 290 transmits, to the computing unit 26, the signal Y instructing the computing unit 26 to set the multiplier coefficient of the multiplier 31.

The computing unit 26 sets the multiplier coefficient of the multiplier 31 in accordance with the counted value Z of the counter 250. For this reason, the computing unit 26 includes a storage unit 37 that is referenced when selecting the multiplier coefficient corresponding to the counted value Z. A volatile memory such as a SRAM, or a nonvolatile memory such as an EEPROM, may be used as the storage unit 37. An appropriate reference period corresponding to the period of the TES signal, a number M of the periods of the clock signal included in the reference period, and a multiplier coefficient corresponding to the reference period are correlated with one another and plurally stored in the storage unit 37.

For example, a reference period 1/5.2 kHz, a number M1 of the periods included in the reference period 1/5.2 kHz, and a multiplier coefficient 0 are stored in the storage unit 37. A reference period 1/6.25 kHz, a number M2 of the periods included in the reference period 1/6.25 kHz, and a multiplier coefficient 0.25 are also stored in the storage unit 37. A reference period 1/6.94 kHz, a number M3 of the periods included in the reference period 1/6.94 kHz, and a multiplier coefficient 0.5 a real so stored in the storage unit 37. A reference period 1/7.35 kHz, a number M4 of the periods included in the reference period 1/7.35 kHz, and a multiplier coefficient 0.75 are also stored in the storage unit 37. A reference period 1/7.80 kHz, a number M5 of the periods included in the reference period 1/7.80 kHz, a multiplier coefficient 0.85, and a multiplier coefficient 1 corresponding to a reference period shorter than 1/7.80 kHz are also stored in the storage unit 37.

The computing unit 26 successively compares the counted value Z with the number (M1 to M5) of clock signals included in the reference period beginning with M1. Moreover, the computing unit 26 sets, in the multiplier 31, the multiplier coefficient corresponding to the reference period on the basis of the comparison result. For example, the computing unit 26 first compares the counted value Z with M1, and when the counted value Z is greater than M1, the computing unit 26 sets the multiplier coefficient 0 in the multiplier 31. When the counted value Z is less than M1, the computing unit 26 compares the counted value Z with M2. When the counted value Z is greater than M2, the computing unit 26 sets the multiplier coefficient 0.25 in the multiplier 31. This is because, as mentioned previously, the movement of the objective lens 4 in the radial direction is drive-controlled by the tracking actuator 13.

The tracking actuator 13 conducts drive control as a result of the tracking control voltage being applied to the tracking control coil. The tracking control voltage is determined by the level of the objective lens-use pulse. The level of the objective lens-use pulse is a predetermined value in this case. Incidentally, when the moving speed of the optical pickup 1 becomes faster, the inertial force that the objective lens 4 receives becomes larger, and the drive control of the objective lens 4 by the tracking actuator 13 is affected by this inertial force. For this reason, there is the potential for the objective lens 4 to be unable to be moved to the position opposing the target track with the level of an objective lens-use pulse that is a predetermined value. Thus, in order to enable the objective lens 4 to be moved to the position opposing the target track, it is necessary to set the level of the objective lens-use pulse to a level corresponding to the moving speed of the optical pickup 1. Thus, if the counted value Z is greater than M2, this means that one period of the TES signal is longer than the reference period 1/6.25 kHz. For this reason, the objective lens 4 can be moved in the radial direction with the level of the objective lens-use pulse of the reference period 1/6.25 kHz corresponding to the moving speed of the optical pickup 1. The computing unit 26 sets the multiplier coefficient 0.25 in the multiplier 31 in order to generate the level of the objective lens-use pulse of the reference period 1/6.25 kHz. When the counted value Z is less than M2, the computing unit 26 successively compares the counted value Z with M3, M4 and M5. Then, the computing unit 26 sets, in the multiplier 31, the multiplier coefficient corresponding to the reference period on the basis of the comparison result.

When the objective lens 4 has reached the target track, the objective lens-use pulse generating unit 27 generates an objective lens-use pulse A with a phase opposite that of the tracking control pulse in order for the target track to be precisely irradiated with the laser light emitted from the objective lens 4. The level of the objective lens-use pulse A is a constant value that determines the position in the radial direction at which the objective lens 4 opposes the optical disk medium 2. The objective lens-use pulse generating unit 27 outputs the objective lens-use pulse A until the end of the switch 350 becomes connected to the contact point A.

The multiplier 31 generates an objective lens-use pulse B in which the level of the objective lens-use pulse A from the objective lens-use pulse generating unit 27 is multiplied by the multiplier coefficient set by the computing unit 26.

The adder 32 adds together the level of the objective lens-use pulse A from the objective lens-use pulse generating unit 27 and the level of the objective lens-use pulse B from the multiplier 31 to generate an objective lens-use pulse C. In other words, when the end of the switch 250 is connected to the contact point A by the switching signal of the comparator unit 290, the objective lens-use pulse C from the adder 32 is outputted to the D/A converter 91. For example, when the multiplier coefficient set in the multiplier 31 is 0.5, the level of the objective lens-use pulse C becomes a level 1.5 times that of the objective lens-use pulse A. Thus, the objective lens-use pulse C counteracts the inertial force that the objective lens 4 receives when the optical pickup 1 jumps tracks, and becomes a level where the objective lens 4 can move to the position at which the target track can be precisely irradiated with the laser light.

<<Operation of the Optical Disk Apparatus >>

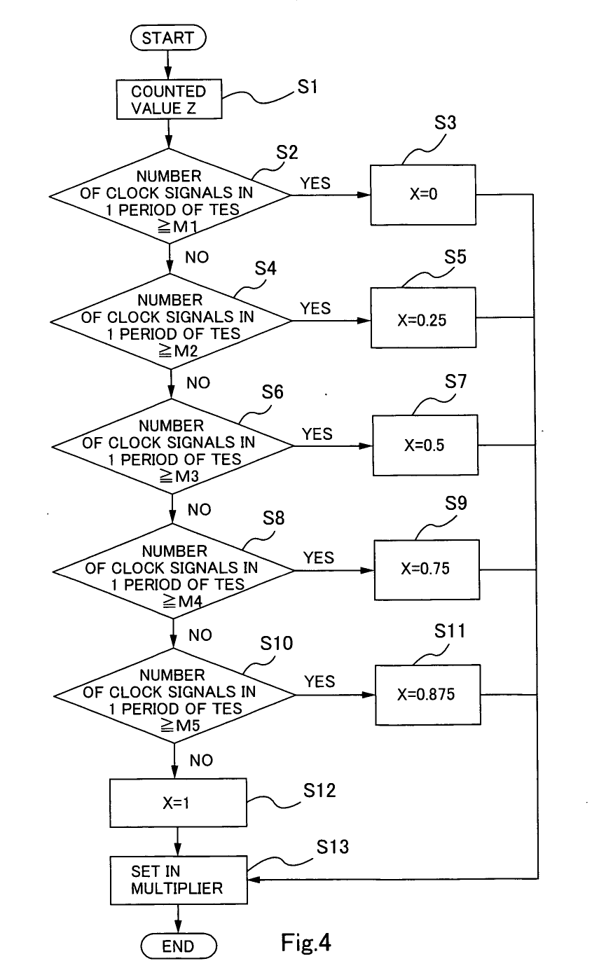

The control of the objective lens at the time of track jumping will be described with reference to FIG. 1 and FIGS. 3 to 5 as the operation of the optical disk apparatus pertaining to the invention. FIG. 4 is a flow chart showing the operation of the computing unit 26. In the optical disk apparatus of the present embodiment, at the normal time when the optical pickup is not track jumping, the switch 351 of the tracking servo processing unit 22 is normally closed. Also, the switch 350 is connected to the contact point B. Moreover, the tracking servo processing unit 22 conducts tracking control.

For example, when an instruction for playing back a predetermined song recorded in the optical disk medium 2 is given by a remote controller or the like (not shown), the instruction control unit 14 receives the instruction signal from the remote controller.

When the instruction control unit 14 has received the instruction signal, the instruction control unit 14 calculates the number of tracks from the current track being irradiated with the laser light by the objective lens 4 to the target track in which the predetermined song is recorded, and then sets that number of tracks as the target track value in the register 28 of the track jump processing unit 21. The instruction control unit 14 also transmits the track jump signal to the track jump processing unit 21, the tracking servo processing unit 22 and the thread servo processing unit 23.

The switch 351 of the tracking servo processing unit 22 is opened by the track jump signal. For this reason, the tracking control pulse generated by the tracking control pulse generating unit 34 is no longer outputted to the D/A converter 91. Thus, at the time of the track jumping of the objective lens 4, control of the objective lens 4 in the X direction by the tracking servo processing unit 22 is no longer conducted.

When the thread servo processing unit 28 receives the track jump signal, the thread servo processing unit 28 outputs, to the D/A converter 92, the thread control pulse for moving the optical pickup 1 to the target track. The D/A converter 92 converts the thread control pulse to an analog value. The driver 112 outputs the analog value from the D/A converter 92 as the thread control voltage and applies this to the thread motor 19. Then, the thread motor 19 is rotated by the thread control voltage, and the optical pickup 1 coupled to the rotating shaft of the thread motor 19 moves to the target track in the +X direction.

When the track jump control pulse generating unit 33 of the track jump processing unit 21 receives the track jump signal, the track jump control pulse generating unit 33 generates the track jump control pulse in order to move the objective lens 4 in the +X direction. Then, the track jump control pulse is outputted to the D/A converter 91 via the switch 350. The D/A converter 91 converts the track jump control pulse to an analog value. The driver 111 outputs the analog value from the D/A converter 91 as the track jump control voltage. Then, the track jump control voltage is applied to the tracking control coil of the tracking actuator 13, and the objective lens 4 moves in the +X direction (FIG. 3; see the track jump control pulse T1).

Even during track jumping, the objective lens 4 continues to irradiate the optical disk medium 2 with the laser light. At this time, the TE signal detector 6 generates the tracking error signal shown in FIG. 3 from the laser light that is reflected from the optical disk medium 2 and received by the light detector 18.

The tracking error signal becomes the TES signal via the A/D converter 71 and is inputted to the counter 250 and the counter 251.

The counter 250 counts the launches of the clock signal in one period from the launch T1 to T2 of the TES signal shown in FIG. 3 (FIG. 3; the clock signals between T1 and T2). Next, the counter 250 is reset to the launch T2 of the TES signal and counts the launches of the clock signal in one period from the launch T2 to T3 of the TES signal (FIG. 3; the clock signals between T2 and T3). Moreover, the counter 250 is reset to the launch T3 of the TES signal and counts the launches of the clock signal in one period from the launch T3 to T4 of the TES signal (FIG. 3; the clock signals between T3 and T4).

The comparator unit 290 compares the counted value of the launches of the TES signal counted by the counter 251 with the value X in which the predetermined value 1 is subtracted by the subtracter 36 from the target track value stored in the register 30. Then, when the counted value of the counter 251 and the value X stored in the register 30 match (FIG. 3; T5), the comparator unit 290 transmits the signal Y to the computing unit 26.

When the computing unit 26 receives the signal Y from the comparator unit 290, the computing unit 26 reads the counted value Z that is the number of periods of the clock signal in one period of the TES signal counted by the counter 250 (FIG. 4; S1).

Then, the computing unit 26 compares the counted value Z with the number M1 of the periods of the clock signal corresponding to the reference period 1/5.2 kHz (FIG. 4; S2). At this time, when the counted value Z is greater than M1 (FIG. 4; YES in S2), the computing unit 26 regards the period of the TES signal as corresponding to the reference frequency 1/5.2 kHz and sets the multiplier coefficient 0 in the multiplier 31. When the counted value Z is less than M1 (FIG. 4; NO in S2), the computing unit 26 compares the counted value Z with the number M2 of the periods of the clock signal corresponding to the reference frequency 1/6.25 kHz (FIG. 4; S4). At this time, when the counted value Z is greater than M2 (FIG. 4; YES in S4), the computing unit 26 regards the period of the TES signal as corresponding to the reference frequency 1/6.25 kHz and sets the multiplier coefficient 0.25 in the multiplier 31. When the counted value Z is less than M2 (FIG. 4; NO in S4), the computing unit 26 compares the counted value Z with the number M3 of the periods of the clock signal corresponding to the reference frequency 1/6.94 kHz (FIG. 4; S6). At this time, when the counted value Z is greater than M3 (FIG. 4; YES in S6), the computing unit 26 regards the period of the TES signal as corresponding to the reference frequency 1/6.94 kHz and sets the multiplier coefficient 0.5 in the multiplier 31. When the counted value Z is less than M3 (FIG. 4; NO in S6), the computing unit 26 compares the counted value Z with the number M4 of the periods of the clock signal corresponding to the reference frequency 1/7.35 kHz (FIG. 4; S8). At this time, when the counted value Z is greater than M4 (FIG. 4; YES in S8), the computing unit 26 regards the period of the TES signal as corresponding to the reference frequency 1/7.35 kHz and sets the multiplier coefficient 0.75 in the multiplier 31. When the counted value Z is less than M4 (FIG. 4; NO in S8), the computing unit 26 compares the counted value Z with the number M5 of the periods of the clock signal corresponding to the reference frequency 1/7.80 kHz (FIG. 4; S10). At this time, when the counted value Z is greater than M5 (FIG. 4; YES in S10), the computing unit 26 regards the period of the TES signal as corresponding to the reference frequency 1/7.80 kHz and sets the multiplier coefficient 0.875 in the multiplier 31. Moreover, when the counted value Z is less than M5 (FIG. 4; NO in S10), the computing unit 26 regards the period of the TES signal as corresponding to a period shorter than the reference period 1/7.80 kHz and sets the multiplier coefficient 1 in the multiplier 31 (FIG. 4; S12). In the present embodiment, description is given assuming that the counted value Z is such that M4<Z<M3. In other words, the multiplier coefficient set in the multiplier 31 becomes 0.75.

Then, the multiplier 31 multiplies the level of the objective lens-use pulse A that is generated by the objective lens-use pulse generating unit 27 and controls the tracking actuator 13 with the multiplier coefficient 0.75 set in the computing unit 26, and generates the objective lens-use pulse B (=objective lens-use pulse A x 0.75). Moreover, the adder 32 adds together the objective lens-use pulse A and the objective lens-use pulse B to generate the objective lens-use pulse C (=objective lens-use pulse A×1.75). In other words, the objective lens-use pulse C shown in FIG. 3 is generated.

Moreover, the comparator unit 291 compares the counted value of the counter 251 with the target track value stored in the register 28. Then, when the counted value of the counter 251 and the target track value stored in the register 28 match (FIG. 3; T6), the comparator unit 291 transmits the switching signal for connecting the end of the switch 350 to the contact point A. Thus, the end of the switch 250 is connected to the contact point A and the objective lens-use pulse C is outputted to the D/A converter 91. The D/A converter 91 converts the objective lens-use pulse C to an analog value. The driver 111 outputs the analog value from the D/A converter 91 as the tracking actuator control voltage. Then, the tracking actuator control voltage is applied to the tracking control coil of the tracking actuator 13, whereby the objective lens 4 moves to the position at which the target track is precisely irradiated with the laser light.

According to the present embodiment, the counter 250 counts the number of periods of the clock signal with a predetermined frequency in one period of the TES signal at the time of track jumping, whereby the moving speed of the objective lens 4 can be detected. Moreover, the objective lens-use pulse A generated by the objective lens-use pulse generating unit 27 can be changed by the computing unit 26, the multiplier 31 and the adder 32 to the objective lens-use pulse C corresponding to the counted value Z of the counter 250. In other words, when the track jumping of the objective lens 4 ends, the target track can be precisely irradiated with the laser light emitted from the objective lens 4.

### Other Embodiments

In the optical disk apparatus pertaining to the invention, description was given above of the control of the objective lens corresponding to the moving speed of the optical pickup at the time of track jumping, but this description is intended to facilitate understanding of the invention and should not be construed as limiting the invention. The present invention can be modified and improved without departing from the gist thereof.

(Comparing the TES Signal and the Reference Period)

In the present embodiment, the multiplier coefficient set in the multiplier was determined by comparing, in the computing unit, the number of periods of the clock signal in one period of the TES signal with the number of clock signals of the reference period, but the invention is not limited to this. For example, the average value of the number of periods of the clock signal in each period of plural periods of the TES signal may be calculated, and the average value may be compared with the number of clock signals of the reference period.

(Computing Unit)

In the present embodiment, the computing unit configuring the level variable unit included a storage unit that was referenced when setting the multiplier coefficient, but the invention is not limited to this. For example, the computing unit may also be configured to execute the operation of setting the multiplier coefficient with an appropriate program, so that the number of periods of the clock signal included in the reference period and the multiplier coefficient corresponding to the reference period are incorporated.

(Frequency of Clock Signal)

In the present embodiment, the period of the clock signal was described as being shorter than the period of the TES signal, but the invention is not limited to this. The multiplier coefficient set in the multiplier may also be determined in accordance with the difference between the period of the clock signal and the period of the TES signal.

1. An optical disk apparatus comprising:
a pulse generator which, when an optical pickup including an objective lens for emitting laser light for recording or playing back information with respect to an optical disk medium has moved in a radial direction of the optical disk medium from a first track formed to a second track in the optical disk medium, generates an objective lens-use pulse for determining an opposing position of the objective lens with respect to the radial direction of the optical disk medium;
a drive unit that determines the opposing position of the objective lens on the basis of the objective lens-use pulse;
a speed detector that detects the speed of the optical pickup when the optical pickup moves from the first track to the second track; and
a level variable unit that makes variable the level of the objective lens-use pulse in accordance with the detection result of the speed detecting unit, wherein the drive unit changes the opposing position of the objective lens with respect to the radial direction of the optical disk medium in accordance with the level of the objective lens-use pulse.

2. The optical disk apparatus of claim 1, wherein when the optical pickup moves from the first track to the second track, the speed detecting unit compares a tracking error signal generated by the optical disk medium being irradiated with the laser light with the period of a clock signal of a predetermined frequency, and on the basis of the comparison result, detects the speed when the optical pickup moves from the first track to the second track.

3. The optical disk apparatus of claim 2, wherein the speed detecting unit
compares the tracking error signal with the period of a clock signal of a predetermined frequency higher than the frequency of the tracking error signal, and
on the basis of the number of periods of the clock signal included in one predetermined period of the tracking error signal, detects the speed when the optical pickup moves from the first track to the second track.

4. The optical disk apparatus of claim 3, wherein the speed detecting unit
includes a counter that is reset by a binarized signal of the tracking error signal and counts the clock signals, and
uses the counted value of the counter as the number of periods of the clock signal included in the one predetermined period of the tracking error signal.

5. The optical disk apparatus of claim 3, further including a storage unit that plurally correlates and stores numbers of predetermined periods of the clock signal and level setting values of the objective-lens use pulse, wherein
the level variable unit compares the number of periods of the clock signal included in one predetermined period of the tracking error signal with the number of predetermined periods of the clock signal, and sets the level of the objective lens-use pulse to one times or more in accordance with the level setting value of the objective lens-use pulse of the storage unit corresponding to the comparison result.

6. The optical disk apparatus of claim 5, wherein the level variable unit includes
a multiplier that multiplies the level of the objective lens-use pulse with a multiplier coefficient of 0 to 1, and
an adder that adds together the level of the objective lens-use pulse and the level of the objective lens-use pulse outputted from the multiplier,
with the multiplier coefficient of the multiplier being set by the level setting values of the objective lens-use pulse.
